(19) United States
(12) Patent Application Publication
(10) Pub. No.: US 2013/0300102 A1
(43) Pub. Date: Nov. 14, 2013

(54) HYBRID LABEL

(71) Applicant: UNIVERSAL SURVEILLANCE SYSTEMS, LLC, Rancho Cucamonga, CA (US)

(72) Inventors: Adel O. Sayegh, Rancho Cucamonga, CA (US); Edgardo Redublo, Chino Hills, CA (US); Junjie Wang, Hangzhou (CN); Deyun Cong, Hangzhou (CN)

(21) Appl. No.: 13/860,789

(22) Filed: Apr. 11, 2013

Related U.S. Application Data
(60) Provisional application No. 61/623,053, filed on Apr. 11, 2012.

(30) Foreign Application Priority Data
May 29, 2012 (CN) 201220254257.6

(51) Int. Cl. B42D 15/00

(52) U.S. Cl. CPC B42D 15/00
USPC 283/81

(57) ABSTRACT

The present invention provides a hybrid label having a plurality of detachably coupled labels.

### CROSS-REFERENCE TO RELATED APPLICATIONS

This Application claims the benefit of priority of the co-pending U.S. Provisional Utility Patent Application No. 61/623,053, filed Apr. 11, 2012; this Application is also a Continuation In Part (CIP) claiming the benefit of priority of Chinese Patent Application 201220254257.6, filed May 29, 2012, now Chinese Patent No. 2655792 issued on Jan. 23, 2013; the entire disclosures of all of which applications and patents is expressly incorporated by reference in their entirety herein. Where a definition or use of a term in an incorporated reference is inconsistent or contrary to the definition of that term provided herein, the definition of that term provided herein applies and the definition of that term in the incorporated reference does not apply.

### BACKGROUND OF THE INVENTION

1. Field of the Invention

This invention relates to labels and, more particularly to multi-layered hybrid label with security redundancies.

2. Description of Related Art

Conventional printed and security labels are well known and have been in use for a number of years. Regrettably, most conventional printed or security labels suffer from obvious disadvantages in that they may easily be removed from a protected item to which they adhere, and or may easily be severed, rendering the printed or security label inoperable and leaving the item unprotected and vulnerable to theft. Most conventional security labels that have a thin layer of traced circuitry (a thin layer of printed or a tracing of inductor “L” and capacitor “C” topography—an “LC circuit”) may easily be rendered inoperable when the circuit layer is severed by hand (e.g., nails) or by an object. Further, removing or peeling off the printed or security label from a protected item obviously leaves the item vulnerable to theft but also removes any evidence of association between the item and a retailer. That is, once the printed or security label is removed from the item, the item can no longer be traced back to the retailer, with the item easily removed from a merchant location, and resold without any proof as to where the item originated.

A further disadvantage with conventional security labels that include a circuit layer is that they are usually limited to be adhered to flat surfaces of an item so to maintain the frequency at which the layered circuit was designed to resonate. Therefore, placement of conventional security labels with a circuit layer onto small objects or items with sharp curves that would compel the security label to bend for adhesion would also bend the circuit layer, which would change the frequency at which the circuit is to resonate. Obviously any inadvertent change in the resonance frequency of the security label would either trigger false alarm or no alarm at all. Conventional solution for placement of conventional security labels onto curved surfaces is to reduce the size of the security label (and hence, the circuit layer), enabling the labels to adhere flatly onto surfaces with some curved topography. However, reducing the size of the circuit layer (similar to using a smaller sized capacitor and smaller inductor with reduced windings) weakens the electromagnetic signal received and or transmitted (reflected) from the security label, requiring modifications to the various aspects of the entire security system (e.g., increasing the sensitivity of the transceiver pedestals).

Accordingly, in light of the current state of the art and the drawbacks to current labels (printed or security) mentioned above, a need exists for a label that would have security redundancies that when removed or severed, the security redundancies would continue to protected the item and further, would continue to provide information that associate the protected item with its original merchant (the item would be traceable to original owner). Further, a need exist for a label of sufficient size that would be applicable and used on most types of surfaces with various topographies and would not be limited to adhesion onto only flat surfaces.

### BRIEF SUMMARY OF THE INVENTION

A non-limiting, exemplary aspect of an embodiment of the present invention provides a hybrid label, comprising:

a plurality of detachably coupled labels.

Another non-limiting, exemplary aspect of an embodiment of the present invention provides a hybrid label, comprising:

one or more security labels; and

one or more depositing labels detachably associated with one or more security labels for added security redundancies.

Still another non-limiting, exemplary aspect of an embodiment of the present invention provides a hybrid label, comprising:

a first protective and isolative layer;

a first adhesive layer;

EAS module layer;

a second adhesive layer coupling the EAS module layer with a depositing label;

the depositing label comprising:
a second protective and isolative layer;
a release layer that is covered over on top by the second protective and isolative layer;
a mark layer positioned between the release layer and a final, adhesive layer;
where release layer facilitate detachment and removal of the EAS label with the second protective and isolative layer of a print label, leaving the mark layer associate with an article.

A further non-limiting, exemplary aspect of an embodiment of the present invention provides a hybrid label, comprising:

security label detachably coupled with a depositing label by a first adhesive layer, with the depositing label comprising:

a protective and isolative layer covered on top by the first adhesive layer;

a releasing layer for releasing security label and the protective and isolative layer from an underlying mark layer that facilitates the detachment and removal of the security label, with the mark layer having a bottom surface covered by a second adhesive layer for coupling the mark layer with an article.

Yet a further non-limiting, exemplary aspect of an embodiment of the present invention provides a hybrid label, comprising:

security label detachably coupled with a depositing label by a first adhesive layer, with the print label comprising:

a releasing layer for detaching and removing an underlying mark layer, with the mark layer having a top surface covered by a protective and isolative layer; and a bottom surface covered by a second adhesive layer for coupling the hybrid label with an article.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIG. 1 is a non-limiting exemplary general overview schematic illustration of an exploded view of an embodiment of a hybrid label in accordance with the present invention; and

FIGS. 2A to 2F are non-limiting, exemplary illustrations of an application of an embodiment of a hybrid label in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

In the description given below and the corresponding set of drawing figures, when it is necessary to distinguish the various layers, members, elements, sections/portions, components, or any other aspects (functional or otherwise) or features of a device(s) or method(s) from each other, the description and the corresponding drawing figures may follow reference numbers with a small alphabet character such as (for example) “labels 102a, 102b, 102c, etc.” If the description is common to all of the various layers, members, elements, sections/portions, components, or any other aspects (functional or otherwise) or features of a device (s) or method(s) such as (for example) to all labels 102a, 102b, 102c, etc., then they may simply be referred to with reference number only and with no alphabet character such as (for example) “label 102.”

Throughout the disclosure, the term “label(s)” is used when referring to any type of tag, sticker, ticket, decal, etc. that may have one or more layers. The specific term “depositing label” is generally defined as one that may include a mark, indicia, print layer (e.g., such as conventional warning labels or tickets, decals, tags, etc.) that adheres (or fixes) onto an item. The depositing label simply leaves, fixes, or deposits a logo, print, indicia or mark (or some indication) on the protected merchandise. The mark, indicia, indication or print may be a unique indelible mark, indicia, logo, trademark, or even an invisible signature that remains (or is fixated) on the protected merchandise to identify or trace the merchandise. The mark, indicia, print, etc. may contain information that may possibly identify the owner of the merchandise. It may leave an RFID label, Ultra Violet or Infra Red light sensitive markings, Quick Response (QR) code, or even microdots embedded with information. The specific term “security label” is generally defined as one that may include security devices such as sensors or Electronic Article Surveillance (EAS) devices. Therefore, the phrase “label” used throughout the disclosure may encompass depositing labels, security labels, or any combinations thereof.

Throughout the disclosure, references to any particular security Electronic Article Surveillance (EAS) systems, non-limiting, non-exhaustive listings of examples of which may include EAS systems (which may optionally be of type that may be deactivated by authorized users) based on Radio Frequency (RF), RF ID, Acousto-magnetic (AM), Microwave (MW), etc. are meant as illustrative and for convenience of example, only. Accordingly, any one or more embodiments of the disclosed hybrid labels in accordance with the present invention should not be limited to or exclusively associated with any specifically mentioned EAS security system disclosed. Further, throughout the disclosure, references to any particular circuit topography or circuit layer (if any) of any hybrid label associated with any specific EAS system (for example an Inductor-Capacitor (LC) circuit trace for an RF EAS system, etc.) disclosed should not be limiting and is meant as an example and for discussion purposes.

The present invention provides a hybrid label that is comprised of one or more labels (that are fully modularized) that are used in combination to provide security redundancies. The hybrid label provides security redundancies so that when a label of the hybrid label is removed or severed, underlying second or lower label of the hybrid label (functioning as redundancy labels) continue to protected the item and further, continue to provide information that associate the protected item with its original merchant (i.e., the item would be traceable to original owner). Further, one or more embodiments of the hybrid label are of sufficient size that may be applicable and used on most types of surfaces with various topographies and is not limited to coupling onto only flat surfaces. The hybrid labels of the present invention are durable, reliable, and secure, and have flexibility in use and application, are cost effective and multi-purpose, and have a wide range of sizes that may be used for protection of various types of articles. The labels in the hybrid label may be identical or different. For example, a label (e.g., a lower or bottom layer label of the hybrid label) may be a label that simply leaves an indicia or mark (or some indication) on the protected merchandise where as another label (e.g., an upper or top layer label) of the hybrid label may include EAS functionalities.

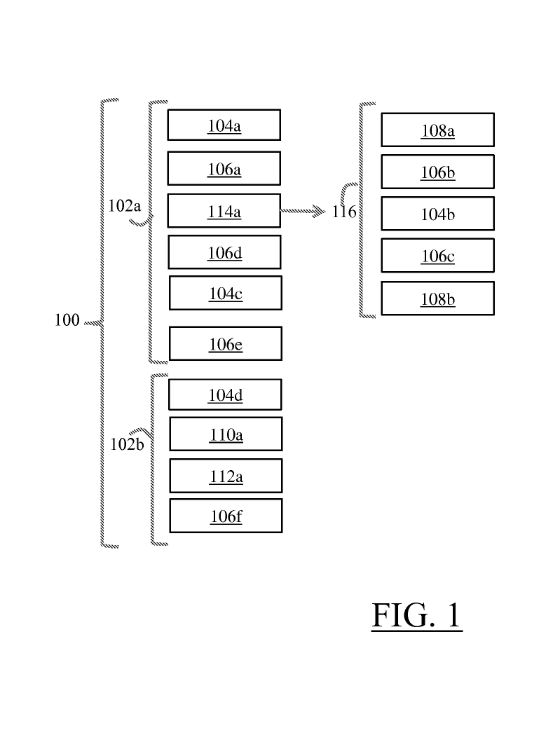

FIG. 1 is a non-limiting exemplary general overview schematic illustration of an exploded view of an embodiment of a hybrid label in accordance with the present invention. As illustrated, the hybrid label 100 is comprised the plurality of labels 102 that may include one or more security labels 102a, one or more depositing labels 102b, or a combination of one or more security labels 102a and one or more depositing labels 102b detachably layered on top of one another for added security redundancies. In other words, the one or more security labels 102a, one or more depositing labels 102b, or a combination of one or more security labels 102a and one or more depositing labels 102b are independent from one another and are modularized and isolated from one another by one or more protective and isolative layers 104. The one or more protective and isolative layers 104 are positioned between various layers of labels 102 and the one or more security labels 102a, one or more depositing labels 102b, or combinations of one or more security labels 102a and one or more depositing labels 102b to thereby isolate and modularize various layers of the labels 102 and the one or more security and depositing labels 102a and 102b. Accordingly, the peeling off of (or removal) of any one or more security labels 102a, depositing labels 102b, or a combinations of security labels 102a and depositing labels 102b does not affect other remaining one or more security labels 102a, depositing labels 102b, or a combinations of security and depositing labels 102a and 102b isolated by the one or more protective and isolative layers, providing added security redundancies.

As further illustrated in FIG. 1, the security labels 102a, depositing labels 102b, or a combinations of security and depositing labels 102a and 102b are detachably stacked on top of one another forming the multiple layer hybrid label 100, with modularized security redundancies. The set of underlying lower layered security, depositing, or a combinations of security and depositing labels 102 are isolated from one another and from a top level security or depositing label 102 that when removed, continue to remain associated with a protected item.

In general, a first label 102 (such as security label 102a) includes a transparent protective and isolative layer 104 with a bottom surface having an adhesive material 106. A security device 114 such as an EAS module 114a that may include a circuit layer with a topographical trace of a circuit is included in the security label 102a of the hybrid label 100. The security device 114 may comprise of one or more layers 116 (detailed below), and is couples to the bottom surface of the transparent protective and isolative layer 104a via the adhesive layer 106a, and includes a bottom surface that has a layer of adhesive 106d. Further included in the security label 102b is another protective and isolative layer 104c with a top surface that couples with the bottom surface of the security device 114 via the adhesive layer 106d.

The hybrid label 100 further includes at least one, second label 102 (e.g., the depositing label 102b) having a top protective and isolative surface layer 104d that is coupled with an adhesive layer 106e that couples the first label 102a with the second label 102b. The depositing label 102b includes a decoupling mechanism in a form of a releasing layer 110a (detailed below) that facilitates decoupling of the remaining layers and or labels from the bottom surface of the protective and isolative layer 104d of the depositing labels 102b, and has a bottom surface with a coupling mechanism (adhesive layer 106f) that strongly attaches the mark layer 112a to an article for protection for added security redundancies.

The releasing layer 110a allows an authorized person (if desired) to remove upper layer labels (for example, after the hybrid label 100 is properly deactivated in well known manner) without damaging the lower layer labels. Accordingly, even after proper deactivation of the hybrid label 100 and removal of upper layer labels (if desired), the now deactivated lower layer labels continue to be associated with the article without being damaged. Alternatively, if an unauthorized person removes upper layer labels (without the hybrid label 100 being properly deactivated by an authorized person), the lower layered labels will not be damaged, and will continue to be fully intact, functional, and associated with the protected article. Therefore, removing or peeling off the upper layered labels from a protected item would not leave the item vulnerable to theft, and also would not remove any evidence of association between the item and a retailer. That is, once the upper-layered labels are removed from the item, the item is still protected and may be traced back to the retailer due to the remaining lower layered labels.

In general, the lower or bottom layered labels and layers have a surface area that are smaller than a surface area of an immediate, top layer or label. The larger surface of the upper layers enables their detachment or removal without much interference with the smaller sized lower layers. Accordingly, the surface area of the first (upper or top) label (e.g., security label 102a) is larger than the surface area of the second (lower or bottom) label (e.g., depositing label 102b). Therefore, each descending layer has a smaller surface area then the one above it so that the lower level layer would not be removed when the upper layer is removed.

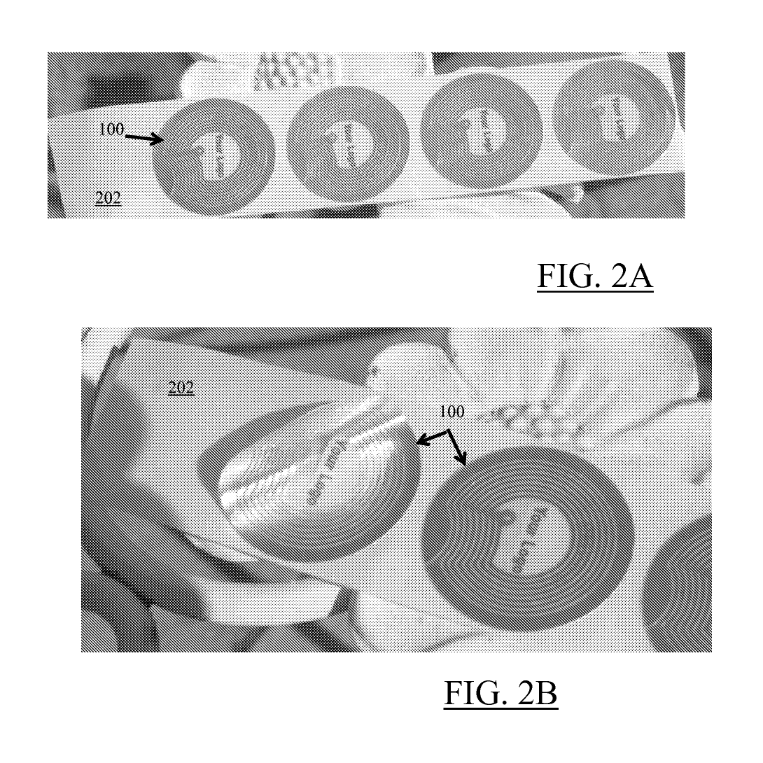

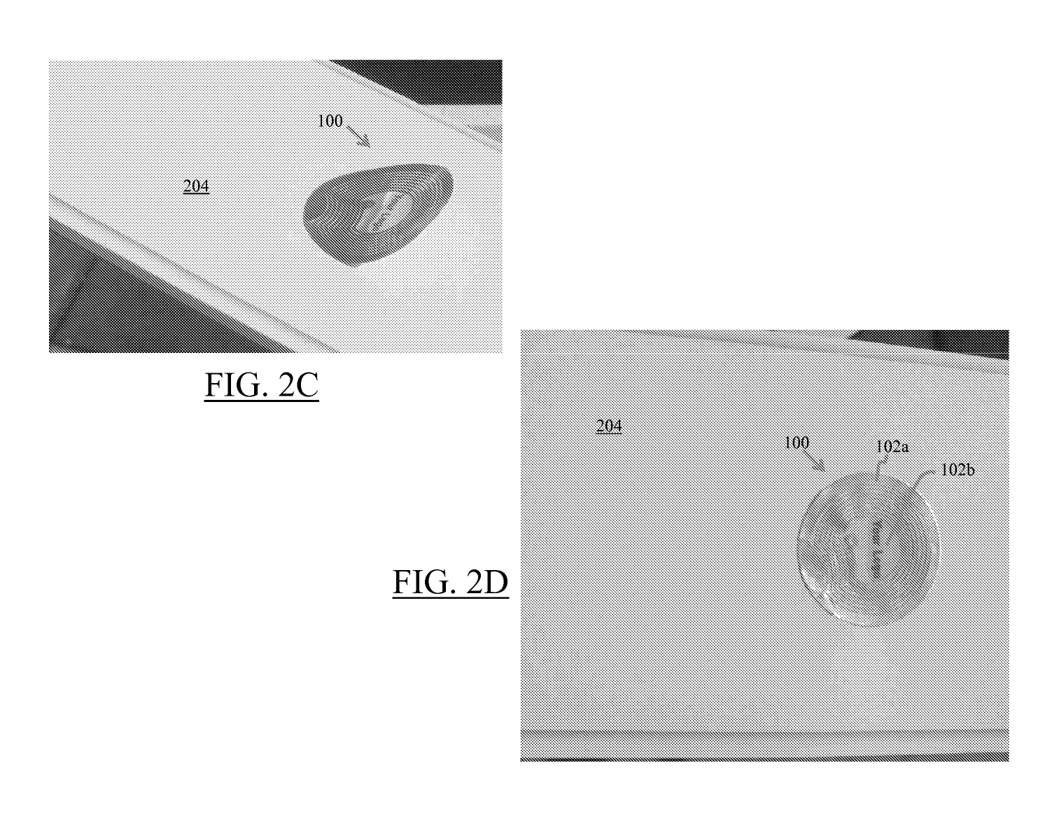

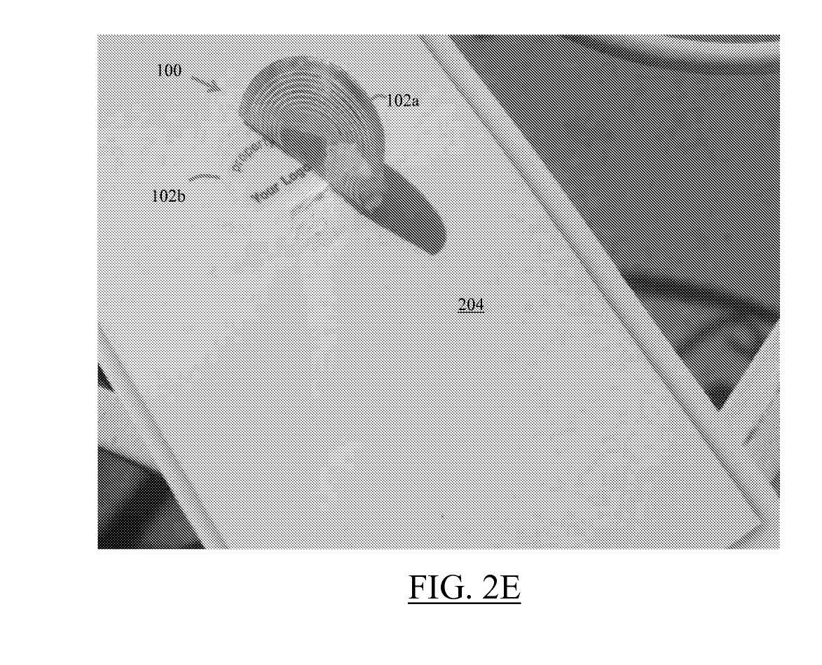

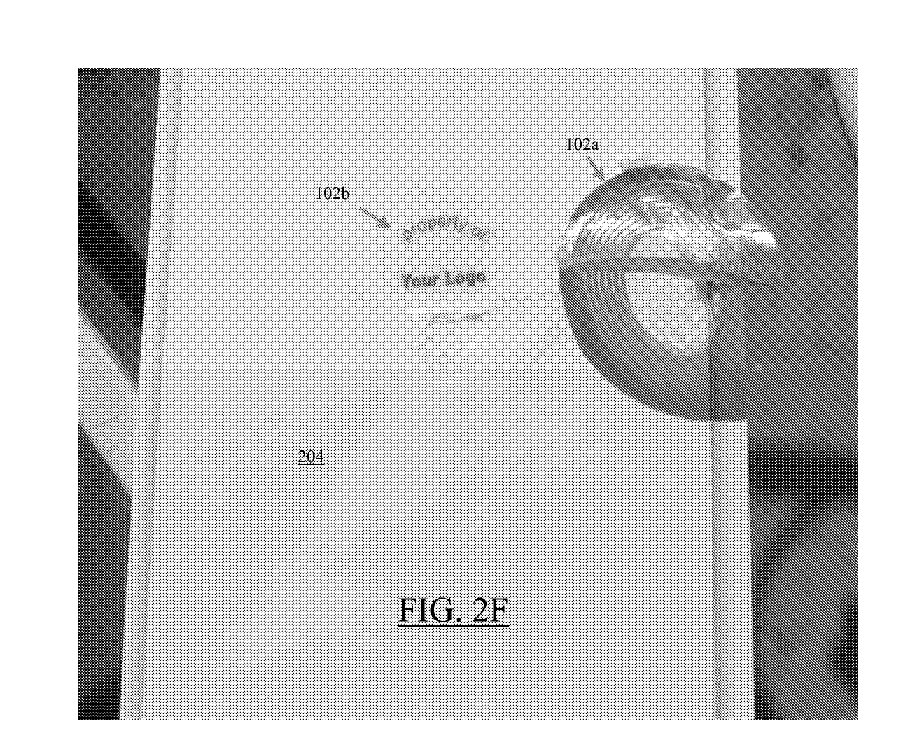

FIGS. 2A to 2F are non-limiting, exemplary illustrations of an embodiment of a hybrid label in use in accordance with the present invention. In the exemplary instance illustrated in FIGS. 2A to 2F, the hybrid label 100 is comprised of a combination of an RF EAS label 102a and a logo depositing label 102b. The hybrid labels 100 may be organized onto a sheet similar to a roll or sheet of stamps (best shown in FIG. 2A) on a wax like paper 202 where they can individually be peeled off (as illustrated in FIG. 2B), and placed onto a desired article 204 as shown in FIGS. 2C and 2D. As illustrated in FIGS. 2C and 2D and described in relation to FIG. 1, the larger sized upper adhesive layer 106e and the smaller sized lower adhesive layer 106f of the hybrid label 100 adhesively couple the label 100 with the article 204.

As illustrated in FIG. 2D, in this non-limiting, exemplary instance, the desired logo (which is the mark layer 112a as part of the depositing label 102b) is clearly visible underneath the upper, security label 102a. As best illustrated in FIGS. 2E and 2F, if an unauthorized users peels off the security label 102a of the hybrid label 100 off of the article 204 (as shown, with the security label 102a peeled off and juxtaposed to the side of the depositing label 102b for illustration), the depositing label 102b, and more particularly, the mark layer 112a (with the indicated “Property of Your Logo”) will continue to remain on the article 204 without any damage. Therefore, removing or peeling off the upper layered labels from a protected item 204 would not leave the item 204 vulnerable to theft, and also would not remove any evidence of association between the item 204 and a retailer (with its logo). That is, once the upper-layered labels are removed from the item 204, the item 204 is still protected and may be traced back to the retailer due to the remaining lower layered labels or layers (in this non-limiting exemplary instance shown in FIGS. 2A to 2F, the remaining layer may be a logo).

Referring back to FIG. 1, in particular, an embodiment of the illustrated hybrid label 100 may include a layer the protective and isolative layer 104a. In general, any one or more of the protective and isolative layers 104 illustrated in FIG. 1 may comprise of any suitable non-metallic material (with or without printed matter thereon). Non-limiting, non-exhaustive list of suitable non-metallic material as protective and isolative layers 104 may include any one or combinations of one or more of acetate, bi-axially oriented polypropylene (BOPP), polyethylene terephthalate (“PET”), polyurethane, a polypropylene, polyethylene, other polymeric material or films, including polyvinyl chloride, polystyrene, and other engineering thermoplastics, etc.

As further illustrated, an embodiment of the hybrid label 100 may include one or more adhesive layer 106. In general, any one or more of the adhesive or coupling layers 106 illustrated in FIG. 1 may comprise of any well known, and conventionally used adhesive that is used within the labeling industry such as a Henkel Hot Melt Adhesive. An embodiment of the hybrid label 100 may also include a security device 114, which in this non-limiting, exemplary instance may comprise of an EAS module layer 114a, a non-limiting, example of which may include an EAS RF circuit, tuned to a desired frequency.

As further illustrated in FIG. 1, the non-limiting, exemplary EAS module layer 114a is comprised of a plurality of layers 116, which may include a first EAS layer 108a, which may be comprised of a first EAS element such as one or more inductor elements L, which is covered over on top by the adhesive layer 106a that couples a top surface of the first EAS layer 108a with a bottom of the protective and isolative layer 104a. A bottom surface of the first EAS layer 108a (e.g., the inductor element L) is covered over by a second adhesive layer 106b, which is coupled with another protective and isolative layer 104b, a bottom surface of which includes an adhesive layer 106c.

The plurality of the layers 116 of the EAS module layer 114a further include a second EAS layer 108b of a second EAS element (e.g., one or more Capacitors C), which is covered over on top by the adhesive layer 106c that couples a top surface of the second EAS layer 108b with a bottom of the protective and isolative layer 104b. The first and second EAS layer 108a and 108b of the first and second EAS elements (e.g., L-C) form a non-limiting, exemplary LC circuit tuned to resonate at a desired frequency, forming an RF EAS circuit. The EAS module 114a is finally coupled with a protective and isolative layer 104c by an adhesive layer 106d, forming the final layers of the security label 102a. As illustrated and described, the security label 102a is fully modularized, independent, and functional.

The present invention provides an additional adhesive layer 106e to couple the security label 102a with the illustrated depositing label 102b. Accordingly, the final protective and isolative layer 104c of the security label 102a includes the additional adhesive layer 106e, which couples the first protective and isolative layer 104d of the depositing layer 102b with the final layer of protective and isolative layer 104c of the security label 102a.

In particularly, the depositing label 102a is comprised of the protective and isolative layer 104d, which encapsulates (with the final adhesive layer 106f) a decoupling or release layer 110a that is covered over on top by the protective and isolative layer 104d. The decoupling or release layer 110a is generally comprised of a release oil, non-limiting example of which may include any well known silicon based oil. The application of the release oil to form the decoupling layer 110a is similar to application and formation of any of the adhesive layers. The oil in the decoupling layer facilitates in separation, removal and peeling off of the security label 102a (with the adhesively coupled protective and isolative layer 104d of the depositing label 102b) from the mark layer 112a (the bottom of which is adhesively coupled with an article by the adhesive layer 106f). Accordingly, the release or decoupling layer 110a facilitates separation of the one label from another without damaging the lower layered labels of the hybrid label 100. In other words, the oil in the decoupling layer 110a prevents the mark layer 112a from being damaged or peeled off of the surface of the article 204 with which it is coupled. As further illustrated, the mark layer 112a is positioned between the release layer 110a and a final layer of adhesive layer 106f, with the release layer 110a facilitating detachment and removal of the EAS label 102a with the protective and isolative layer 104d of the depositing label 102b, leaving the mark layer 112a associate with the article 204.

It should be noted that in general, although the order of the protective and isolative layer 104d and the decoupling layer 110a may be interchanged, the illustrated order is preferred because the order illustrated places the decoupling or release layer 110a on top of the mark layer 112a, which effectively leaves the mark (exemplarily shown in FIGS. 2A to 2F) and only the mark layer 112a (substantially) flush with the surface of the article 204 to which the depositing label 102b is attached. This means that only mark 112a and adhesive 106f layers remain on the surface of the article 204 with no other layers (such as layer 104d to be able to be peeled off or scratched). The protective and isolative layer 104d is removed with the RF label since this layer is adhesively coupled with the adhesive layer 106e of the security label 102a. The oil within the decoupling layer 110a easily enables the entire security label 102a and the protective and isolative layer 104d of the depositing label 102b to be detached from the remaining lower layers without damaging the lower layers. The remaining mark layer 112a (which may be an ink) cannot be removed by scratching or peeling off. In other words, there is no layer left above the mark layer 112a to remove and what remains is only an ink impression imprinted onto the article.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, the position or layer order of the various layers and or labels may be varied, a non-limiting example of which may include switching the layer orders between layer 110a and 104d within the depositing label 102b. That is, the decoupling (or releasing) layer 110 may be coupled with the bottom surface of the adhesive layer 106e on top of the protective and isolative layer 104d. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A hybrid label, comprising:
a plurality of detachably coupled labels.

2. The hybrid label as set forth in claim 1, wherein:
the plurality of labels are comprised of:
one or more security labels, one or more depositing labels, or a combination of one or more security labels and one or more depositing labels detachably layered on top of one another for added security redundancies.

3. The hybrid label as set forth in claim 2, wherein:
one or more security labels, one or more depositing labels, or a combination of one or more security labels and one or more depositing labels are independent from one another and are modularized and isolated from one another by one or more isolation layers.

4. The hybrid label as set forth in claim 3, wherein:
the one or more isolation layers are positioned between one or more layers of one or more security labels, one or more depositing labels, or combinations of one or more security labels and one or more depositing labels to thereby isolate and modularize one or more security and depositing labels, providing added security redundancies.

5. The hybrid label as set forth in claim 4, wherein:
removal of any one or more security labels, depositing labels, or a combinations of security labels and depositing labels does not affect other remaining one or more security labels, depositing labels, or a combinations of security labels and depositing labels isolated by the one or more isolation layers.

6. The hybrid label as set forth in claim 5, wherein:
security labels, depositing labels, or a combinations of security and depositing labels are detachably stacked on top of one another forming a multiple layer hybrid label, with modularized security redundancies.

7. The hybrid label as set forth in claim 6, wherein:
a set of underlying lower layered security, depositing, or a combinations of security and depositing labels are isolated from one another and from a top level security or depositing label that when removed, continue to remain associated with a protected item.

8. The hybrid label as set forth in claim 1, wherein:
a first label that includes:
a first transparent protective layer with a bottom surface having an adhesive material;
a circuit layer with a topographical trace of a circuit that couples to the bottom surface of the first transparent protective layer, and includes a bottom surface that has a layer of adhesive; and
an isolation layer with a top surface that couples with the bottom surface of the circuit layer, and a bottom surface; and
at least one second label;
the at least one second label having a top surface that is detachably carried by the bottom surface of the isolation layer and coupled onto an item, which includes a decoupling mechanism that facilitates decoupling from the bottom surface of the isolation layer, and a bottom surface with a coupling mechanism that strongly attaches to the item for protection for added security redundancies.

9. The hybrid label as set forth in claim 8, wherein:
a lower layer has a surface span that is smaller than a surface span of an immediate, upper layer.

10. The hybrid label as set forth in claim 9, wherein:
the second label is one of security label and depositing label.

11. The hybrid label as set forth in claim 9, wherein:
a security label of one or more security labels is comprised of:
at least one circuit layer.

12. The hybrid label as set forth in claim 10, wherein:
the circuit layer is comprised of circuitry responsive to an electronic surveillance system.

13. The hybrid label as set forth in claim 11, wherein:
the security label is further comprised of:
a mark layer; and
a protective cover layer that protects the marking of the mark layer.

14. The hybrid label as set forth in claim 12, wherein:
a depositing label of one or more depositing labels is comprised of:
an indicia on a top surface, and a coupler in a form of an adhesive at a bottom surface.

15. A hybrid label, comprising:
one or more security labels; and
one or more depositing labels detachably associated with one or more security labels for added security redundancies.

16. The hybrid label as set forth in claim 15, wherein:
a security label of one or more security labels is comprised of:
an EAS module.

17. The hybrid label as set forth in claim 16, wherein:
the EAS module is coupled in between protective isolative layers.

18. The hybrid label as set forth in claim 16, wherein:
the EAS module is coupled with a next EAS module within the same security label.

19. The hybrid label as set forth in claim 16, wherein:
the EAS module is isolated from the next EAS module within the same security label by one or more protective isolative layers.

20. The hybrid label as set forth in claim 16, wherein:
one of a first and second outer layers of the security label is coupled with one of a next security label and the depositing label.

21. The hybrid label as set forth in claim 16, wherein:
the EAS module is comprised of one or more layers of one or more EAS elements.

22. The hybrid label as set forth in claim 16, wherein:
the one or more EAS elements are isolated by one or more protective isolative layers.

23. The hybrid label as set forth in claim 15, wherein:
a depositing label of one or more depositing labels is comprised of:
a mark layer.

24. The hybrid label as set forth in claim 23, wherein:
the mark layer is coupled with a protective isolative layer.

25. The hybrid label as set forth in claim 24, wherein:
the mark layer is coupled with a next mark layer within the same depositing label.

26. The hybrid label as set forth in claim 25, wherein:
the mark layer is isolated from a next mark layer within the same depositing label by one or more protective isolative layers and one or more release layers.

27. The hybrid label as set forth in claim 16, wherein:
one of a first and second depositing label outer layers is coupled with one of a next depositing label and the security label.

28. A hybrid label, comprising:
a first protective and isolative layer;
a first adhesive layer;
EAS module layer;
a second adhesive layer coupling the EAS module layer with a depositing label;
the depositing label comprising:
a second protective and isolative layer;
a release layer that is covered over on top by the second protective and isolative layer;
a mark layer positioned between the release layer and a final, adhesive layer;
where release layer facilitate detachment and removal of the EAS label with the second protective and isolative layer of a print label, leaving the mark layer associate with an article.

29. The hybrid label as set forth in claim 28, wherein:
the first protective isolative layer is comprised of a non-metallic material.

30. The hybrid label as set forth in claim 29, wherein:
the non-metallic material is polymeric film.

31. The hybrid label as set forth in claim 28, wherein:
the EAS module is comprised of:
a first EAS layer of a first EAS element, which is covered over on top by the first adhesive layer that couples a top surface of the first EAS layer with a bottom of the first protective and isolative layer, with a bottom surface of the first EAS layer covered over by a second adhesive layer;
a second protective isolative layer is coupled with a bottom of the first EAS layer of the first EAS element by the third adhesive layer, with a bottom of the second protective isolative layer covered by a fourth adhesive layer;
a second EAS layer of a second EAS element, which is covered over on top by the fourth adhesive layer that couples a top surface of the second EAS layer with a bottom of the third protective and isolative layer;
with the first and second EAS layer of the first and second EAS elements forming an EAS circuit.

32. The hybrid label as set forth in claim 28, wherein:
the first EAS element is an inductor and the second EAS element is a capacitor, forming an RF EAS circuit.

33. A hybrid label, comprising:
security label detachably coupled with a depositing label by a first adhesive layer, with the depositing label comprising:
a protective and isolative layer covered on top by the first adhesive layer;
a releasing layer for releasing security label and the protective and isolative layer from an underlying mark layer that facilitates the detachment and removal of the security label, with the mark layer having a bottom surface covered by a second adhesive layer for coupling the mark layer with an article.

34. A hybrid label, comprising:
security label detachably coupled with a depositing label by a first adhesive layer, with the print label comprising:
a releasing layer for detaching and removing an underlying mark layer, with the mark layer having a top surface covered by a protective and isolative layer; and a bottom surface covered by a second adhesive layer for coupling the hybrid label with an article.
